(19) United States
(12) Patent Application Publication
(10) Pub. No.: US 2003/0033126 A1
(43) Pub. Date: Feb. 13, 2003

(54) Modeling biological systems

(76) Inventors: Patrick Denis Lincoln, Woodside, CA (US); Keith Richard Laderoute, Palo Alto, CA (US); A. Merrill Knapp, Menlo Park, CA (US)

Correspondence Address: DAVID L. FEIGENBAUM, Fish & Richardson P.C., 225 Franklin Street, Boston, MA, 02110-2804, US

(21) Appl. No.: 09/855,458

(22) Filed: May 15, 2001

Related U.S. Application Data
(60) Provisional application No. 60/289,973, filed on May 10, 2001.

(51) Int. Cl. G06G 7/48; G06G 7/58

(52) U.S. Cl. 703/11

(57) ABSTRACT

Biological systems are modeled using formal languages and theorem provers and model checkers and term rewriting systems. The models include rules that express a substitution of at least one symbol by at least another symbol. The symbols represent elements of the biological system, and the rules are expressed in a manner that, for example, enables an inference engine to infer alternative results from the system based on an initial hypothetical state.

Inference engines are also applied to symbolically simulate, test properties, and explore the biological system. Abstractions and algorithms can be employed to enable symbolic calculation of state sets for the biological system.

### CROSS-REFERENCE TO RELATED APPLICATIONS

This application claims priority to U.S. Provisional Application No. ______ filed on May 10, 2001, entitled “Modeling Biological Systems”, naming Patrick D. Lincoln and Keith R. Laderoute as inventors, the contents of which are incorporated herein in their entirety by reference.

### BACKGROUND

This invention relates to modeling biological systems.

In many respects, cells are living information processors that respond and adapt to their environment. They can sense multiple parameters, integrate signals, and regulate responses. In multicellular organisms, cells process sensory stimuli from surrounding and even distant cells to orchestrate ornate patterns of differentiation.

The processing of signals in cells is typically mediated by polypeptides and nucleic acids. Human cells, for example, are estimated to have approximately 30,000 genes (International Human Genome Sequencing Consortium (2001) Nature 409:860 and Venter et al. (2001) Science 291:1304). Each cell can express a subset of these genes. Expressed genes are typically translated to produce polypeptides with particular functional properties. Many polypeptides effect cellular events by interacting with other components, either by physically associating with or modifying other compounds. Polypeptides can function together as assemblies, for example in signaling and in providing metabolic pathways. Notably, the functions of polypeptides can be highly regulated, e.g., by other polypeptides. The relationships among polypeptides, nucleic acids, and other cellular components endow cells with a complex network of molecular elements that sense and propagate signals to control cellular behavior.

### SUMMARY

The invention is based, in part, on the discovery that rewriting logic, formal languages, and formal language tools can be used to model interactions in biological systems.

In one aspect, the invention features a method that includes generating a model that includes rules for a biological system. Each of the rules expresses a substitution of at least one symbol by at least another symbol, the symbols representing biological elements. At least some of the rules are expressed in a manner than enables an inference engine to infer alternative results from the system based on an initial hypothetical state.

Implementations of the invention may include one or more of the following features. One or more of the rules may include an operator that expresses a relationship between at least two of the biological elements. The operator may conform to one or more properties selected from the group consisting of associativity, commutativity, idempotence, and identity. For example, the operator may be associative and commutative or associative, commutative, and idempotent. One or more of the rules may express concurrent state transitions. One or more of the rules may be non-terminating. Further, one or more of the rules may be conditional. In certain embodiments, one or more of the rules represents a feedback or feedforward interaction between biological elements. One or more of the rules may be reflective.

At least some of the symbols representing the biological elements are typed. The types may be organized in hierarchical classes.

The method may also include expressing the rules or the system graphically by representing at least some of the symbols as points, and at least some of rules as lines interconnecting points, each interconnected point corresponding to a symbol that is an operand of the rule. The resulting image is a wiring diagram.

In addition, the method may include processing the rules with an inference engine. The inference engine symbolically simulates the biological reactions of interest. The inference engine can determine all possible precursor states for a particular state of interest, given a set of reactions expressed as rules. The inference engine can determine if the rules are terminating and/or Church-Rosser or to identify a feedback or feedforward interaction. The inference engine can process the rules using associative-commutative matching.

The method can further include representing biological states as vectors of logical properties. The method can further include processing the rules using a model checker. It can further include displaying a representation of a decision diagram. It can further include displaying a wiring diagram, e.g., as a hypergraph, and, optionally, computing the transititive closure of that hypergraph.

The method can further include generating an algebraic abstraction of components of the biological system. These algebraic expressions can include compact polynomial expressions of all relevant biological molecules being studied. The symbols may represent molecules in the biological system. For example, one or more symbols may represent an element that is selected from the group consisting of a polypeptide, a nucleic acid, a metabolite, a lipid, and a small molecule. In one embodiment, at least one symbol represents a polypeptide selected from the group consisting of a protein kinase, a nucleotide-binding protein, a transcription factor, a phosphatase, and a protease. In another embodiment, at least one symbol represents a drug, toxin, non-self antigen, or other exogenous agent. In still another embodiment, at least one symbol represents an antibody, a hormone, or a cytokine. In another embodiment, at least one symbol represents a gene or portion of a genetic network.

At least some of the symbols may represent a post-translational modification, e.g., phosphorylation, acetylation, ubiquitination, proteolysis, or methylation.

The model of the biological system may include symbols representing molecules in a first cell and other symbols representing molecules in a second cell. In another embodiment, the model includes symbols represent each individual molecule of a network or system present in a cell. In another embodiment, each organelle of a cell may be represented as a separate collection (e.g. multiset of symbols under an associative and commutative operator), and all membrane transport and other interactions represented as a set of rules. In another embodiment, each organelle, and each membrane of the cell may be represented as a separate collection. In another embodiment, each scaffold protein with its associated proteins and protein complexes may be represented as a separate collection (e.g. set of symbols under an associative, commutative, and idempotent operator).

In another example, the method of generating rules includes parsing a protein-protein interaction map into rules.

In another aspect, the invention features a method of processing an initial state. The method includes receiving in an inference engine a set of symbols that represent a hypothetical initial state of a biological system, and processing the initial state using rules to infer alternative resultant states of the system. Each of the rules expresses a substitution of at least one symbol by at least another symbol. The symbols represent elements of the biological system. In one embodiment, the inference engine determines all possible alternative resultant states of the system from a given initial state.

The inference engine may be configured to detect infinite substitution chains or feedforward and feedback interactions.

The method may also include comparing the resultant states to a set of symbols representing a hypothetical final state of the system to determine if the system may transition from the hypothetical initial state to the hypothetical final state.

The method may also include determining all possible states which lead to a given final state. The method may include determining all possible states which lead to any state satisfying a given predicate.

The method may further include parsing a profile (e.g., a gene expression profile or a polypeptide profile) into symbols, and including at least some (e.g., one or more) of the symbols in the set of symbols representing the hypothetical initial state of the systems. An expression profile includes information about the expression level of genes in a sample or a cell. Similarly, a polypeptide profile includes information about the abundance and/or modification state of polypeptides in a sample or a cell. The profile may be obtained from a biological sample, e.g., a sample associated with, having a predisposition for, or suspected of having a disease or disorder. Examples of diseases and disorders include cancer, diabetes, infection (e.g., by a pathogen), inflammation, and experimentally induced conditions on the cell. The sample can be obtained from a patient or model organism.

The hypothetical initial state may include information about a genetic alteration or mutation (e.g., such as a substitution, insertion, deletion, translocation, or trinucleotide repeat expansion). The method may include providing additional properties (e.g., such as symbols for a drug or other exogenous agent) to the hypothetical initial state, and comparing the alternative resultant states to a reference state, e.g., the state of a normal cell or to the alternative resultant states identified in the absence of the additional property.

In another aspect, the invention features a method of processing an initial state. The method includes receiving a set of symbols in an inference engine, the set representing a hypothetical initial state of a biological system, the symbols representing biological elements of the system; and iteratively substituting symbols representing biological elements by other symbols representing biological elements using rules that represent interactions between the biological elements until a terminal state or until alternative resultant states are detected.

The method may also include outputting the terminal state or at least one of the alternative resultant states, e.g., as a graphical display. The method may also include outputting large sets of possible terminal states as a set of alternatives, e.g., as as a tree or graph representing those possible terminal states. The method may include navigation of such possible terminal states with logical operators.

In still another aspect, the invention features a method of evaluating a rule describing an interaction between elements of a biological system. The method includes: receiving in an inference engine (1) at least first and second sets of symbols, representing hypothetical first and second states of a biological system, the symbols representing biological elements of the biological system and (2) rules that express a substitution of symbols representing biological elements by other symbols representing biological elements; and either determining if one or more of the rules must be true or false for the first state to reach the second state by processing the first state using the rules or determining if the first state can reach or progress to the second state given the rules. For example, the method uses a theorem prover to prove or disprove a theory, e.g., a theory implicit in a contemplated rule. The proof may depend on the interrelationship of the first state with the second state. The hypothetical first and second states may represent different cells, e.g., a normal cell or a cell with a precondition, disease or disorder. If a rule must be true for the biological system to progress from the first state to the second state, the operands of the rule may identify elements of the biological system that are drug targets. For example, preventing the element represented by one of the operands from functioning is likely to prevent the biological system from progressing from the first (e.g., normal) state to the second state (e.g., a diseased state).

In yet another aspect, the invention features a method of modeling a biological system. The method includes identifying gene expression profiles for a first and second sample, each gene expression profile representing the state of a biological system; and generating the first and second sets of symbols from the profiles for each state for input into the inference engine. The first and second samples may have one or more genetic alterations with respect to one another.

The invention also features an article that includes a machine-readable media having encoded thereon a model of a biological system, the model comprising rules that express a substitution of symbols representing biological elements by other symbols representing biological elements. At least some of the rules being expressed in a manner than enables an inference engine to infer alternative results from the system based on an initial hypothetical state.

Also featured is an apparatus that includes a processor and software configured to cause the processor to: receive a set of symbols, the set representing a hypothetical initial state of a biological system, the symbols representing biological elements of the system; and iteratively substitute symbols representing biological elements by other symbols representing biological elements using rules that represent interactions between the biological elements until a terminal state or until alternative resultant states are detected.

Other features and advantages of the invention will be apparent from the description and the claims.

### DESCRIPTION OF DRAWINGS

FIG. 1 is a flow chart of an exemplary process for generating and using rules to model biological systems.

FIG. 2 is a block diagram of the Maude Interpreter's Rewriting Engine.

FIG. 3A and 3B are wiring diagrams for pRb regulatory pathways.

### DETAILED DESCRIPTION

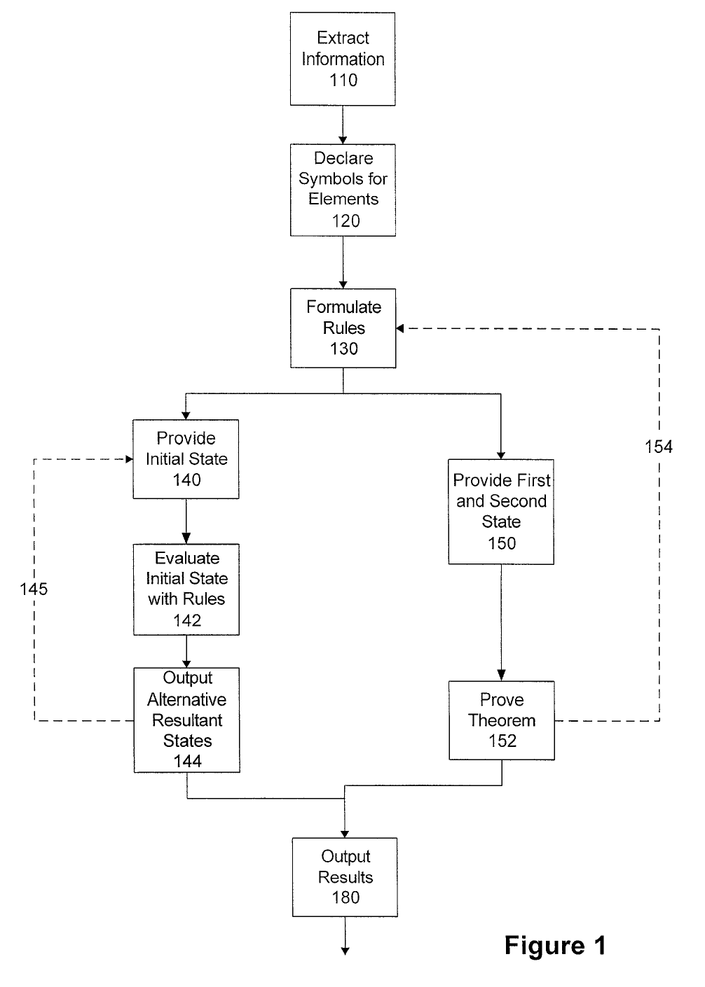

The methods described here generally use the semantic and logical framework of formal methods to model the circuitry of biological systems. Referring to the example shown in FIG. 1, information about a biological system is extracted 110, e.g., from direct observations, experiments, and scientific literature (e.g., PubMed, http://www.ncbi.nlm.nih.gov/entrez/). Elements in the biological system are identified and represented 120 as symbols. Symbols can be related to one another using hierarchical data types. The information is then parsed to formulate 130 rules about the system. The symbols and rules can be used in a variety of methods. Non-limiting examples include evaluating a hypothetical initial state for the biological system 140 and 142; testing a theorem 150 and 152; and checking a model.

To evaluate an initial state, information about a hypothetical initial state is provided 140 (e.g., in symbolic form or as raw data that is processed to symbolic form). An inference engine then evaluates 142 the hypothetical initial state by iteratively processing the rules. One or more terminal states or alternative resultant states are identified and outputted 144. The output can be rendered 180 in a format convenient for a user. In addition, the output can be used for subsequent analysis 145, e.g., as a second hypothetical initial state or for a comparison to one or more reference states.

To test a theorem 152, information about known states of the biological system is identified and parsed into symbolic form 150. A theorem is then evaluated 152 by a theorem prover supplied with rules and the known states of the biological system. If a proof is possible, the theorem prover generates an output 180 as to whether the theorem is true or false given the supplied information. A proven theorem can be used as a rule in subsequent analysis 154.

### Rewriting Logic

Rewriting logic is a form of logical computation that has performance features well suited for the specification and analysis of complex systems. In its simplest embodiment, a rewriting rule is a substitution of symbols. For example, the expression t→t′ is a rewriting that expresses a local state transition in which a portion of a system's state that is represented by t (the arity) is changed to a new state represented by t′ (the coarity). The rewriting operation can be implemented in a computer system to replace instances of the symbol t with t′ in a memory store. Each operator can have one or more of the properties of associativity, commutativity, idempotence, and identity among others. For example, in representing a protein complex of two proteins A and B, we may use the operator “:”, thus forming (A:B).

The operator “:” can be commutative. For example,

(A:B) is equivalent to (B:A)

The operator “:” can be associative. For example,

(A:B):C is equivalent to A:(B:C).

The operator “:” can be idempotent. For example,

(A:A) is equivalent to A.

The operator “:” can have an identity. For example,

(A:Id) is equivalent to A.

Multiple operators can be used to express different relationships between components of a biological system. For example, a first commutative operator “:” can be used to represent protein complexes, and a second associative-commutative operator “;” can be used to represent the cytoplasm. A third associative commutative operator “|” can be used to represent the membrane of an organelle.

Rewriting change can occur independently from any other non-overlapping state change. Hence, the rewriting rules can evaluate concurrent state changes, e.g., for highly nondeterministic concurrent computations. When applied to a hypothetical state of a system, a set of “terminating” rules can arrive at a solution for which no further state transitions can be applied. For example, the set of rules:

a:b→b:a,b:a→c

is terminating. When the input state is “ab,” the rewriting rules reach the solution, “c”. In contrast, “non-terminating” rules do not reach such a solution. For example, the set of rules:

a:b→b:a,b:a→a:b

is non-terminating. When the input state is “ab,” the rewriting rules do not reach a solution for evaluating the system. Non-termination rules can cause “infinite substitution chains.” The inference engine can be configured to detect such infinite substitution chains. Further, the two nonterminating rules above effectively express commutativity. An inference engine may detect rules expressing commutativity of an operator, and replace them with the explicit notation that the operator is commutative. This requires the inference engine to have built-in treatment of commutativity, e.g., including commutative matching. Similarly, the inference engine can detect rules expressing associativity. Such features of the inference engine are termed associative-commutative matching.

An inference engine for processing rewriting rules can implement model checking algorithms. Model checking allows complex properties to be checked over all possible computation paths with relative efficiency (J. R. Burch, et al. (1990) “Sequential Circuit Verification Using Symbolic Model Checking” Proc. 27^{th} DAC 1990; pp. 45-51.).

In some embodiments, the inference engine produces one possible output state as a forward symbolic simulation of the biological system.

In some other embodiments, the inference engine for processing rewriting rules searches for multiple resulting states, or all possible resulting states from a given initial state, e.g., an exhaustive simulation of all possible nondeterministic steps of rewriting. For example, at each step where more than one rewriting rule may be applicable, the engine records record the possible set of choices. The computational inference engine moves forward along one branch of possible system evolution. When a final state is reached, it is recorded or output, e.g., in a compact fashion, and then the inference engine backtrack to the last choice made among possible branches. The inference engine then notes that the fully explored branch is done, and proceed along another branch. In this way, the inference engine can systematically explore all possible outcomes. Efficient implementation of this search for all possible final states is accomplished through the use of efficient indexing and state-storage techniques.

Rewriting logic is “reflective,” and thus can be used to make and evaluate assertions about itself. This capability is also described as “metalogic” or “metaprogramming.” Thus, a rewriting logic computational environment, such as Maude (see below), can be used to formulate metalogic statements that test theories and/or analyze the properties of rules and systems.

Formal methods can be used to query a set of rules to determine if a biological interaction is possible, e.g., to determine if a test rule is consistent with a set of predefined rules or to predict the outcome of adding a test rule to a set of predefined rules. The system can be used to determine if a particular state of a system is possible or reachable given a set of predefined riles. For example, the inference engine can compute if the rules allow the state transitions necessary for an initial state to reach a particular final state. In another example, the inference engine is used to determine if the particular final state is included among the set of alternative resultant states.

For example, rewriting logic can be used to determine if a set of rules are terminating and Church-Rosser, e.g., a property of system that can be reduced to a unique normal form. For example, the Church-Rosser checker described in Duran and Meseguer ((July 2000) “A Church-Rosser Checker Tool for Maude Equational Specifications” SRI International and Universidad de Málaga) can be used to evaluate a set of rules for a biological system.

A rewriting logic interpreter can include syntactic support for object-oriented computation. Symbols can be assigned to object classes, e.g., by declaration or by an operator. Hence, membership axioms can be evaluated, e.g., to determine if a symbol is a member of a particular group. These features and others (such as the use of sorts, subsorts, and operator overloading) enable membership equational logic to be used to analyze biological systems.

Membership equational logic is an equational logic extended with a strong sort (or type) system that allows predicate definitions of sorts, and an explicit predicate enabling testing of membership in a sort. For example, a sort of protein can be defined and a predicate of “kinase?” can be defined. Using membership equational logic, the sort of kinases can be defined as the components of the sort protein that satisfy the “kinase?” predicate. Variables and operators can then be declared to operate on kinases, e.g., activation by phosphorylation and so forth. Other useful examples of these predicate sorts include the set of nonzero numbers (and then division can be declared to be defined only over the sorts of numbers divided by nonzero numbers), and protein complexes satisfying certain interesting properties (and then reactions may be enabled only for protein complexes of that particular sort).

Two examples of computer environments that support rewriting logic are (1) the PVS specification language and theorem prover, and (2) the Maude rewriting engine. Both are available from the SRI Computer Science Laboratory (SRI International, Palo Alto Calif.; http://www.csl.sri.com/). Other examples of computer languages useful for formal methods include Café (Futatsugi and Sawada (1994) “Café as an Extensible Specification Environment” In Proc. Kunming International CASE Symposium) and ELAN (Borovansky et al. (1996) “Controlling Rewriting by Rewriting” in Proc. First International Workshop on Rewriting Logic, Electronic Notes in Theoretical Computer Science. Vol. 4 Elsevier). For a review of rewriting logic see, e.g., Meseguer (1998) “Research Directions in Rewriting Logic” In Computational Logic, ed., Berger and Schwichtenberg, Springer-Verlag; Meseguer (1996) Proc. First International Workshop on Rewriting Logic, Electronic Notes in Theoretical Computer Science. Vol. 4 Elsevier; and Kirchner and Kirchner (1998) Proc. Second International Workshop on Rewriting Logic, Electronic Notes in Theoretical Computer Science. Vol. 15 Elsevier.

### Maude

Maude is a computer-based language that efficiently supports rewriting logic computation, equational computation, and algebraic specification. Some algebraic features of Maude are implemented in the OBJ style (Goguen et al. (2000) “Introducing OBJ” In Software Engineering with OBJ: Algebraic Specification in Action, pp. 3-167, Kluwer). Maude rewriting logic uses algrebraic determination to identify all possible configurations of a system, e.g., a system subject to concurrent changes. With standard hardware, such as a Pentium II processor, the raw rewriting speed of Maude is over 10 million rewrites per second for simple rule sets.

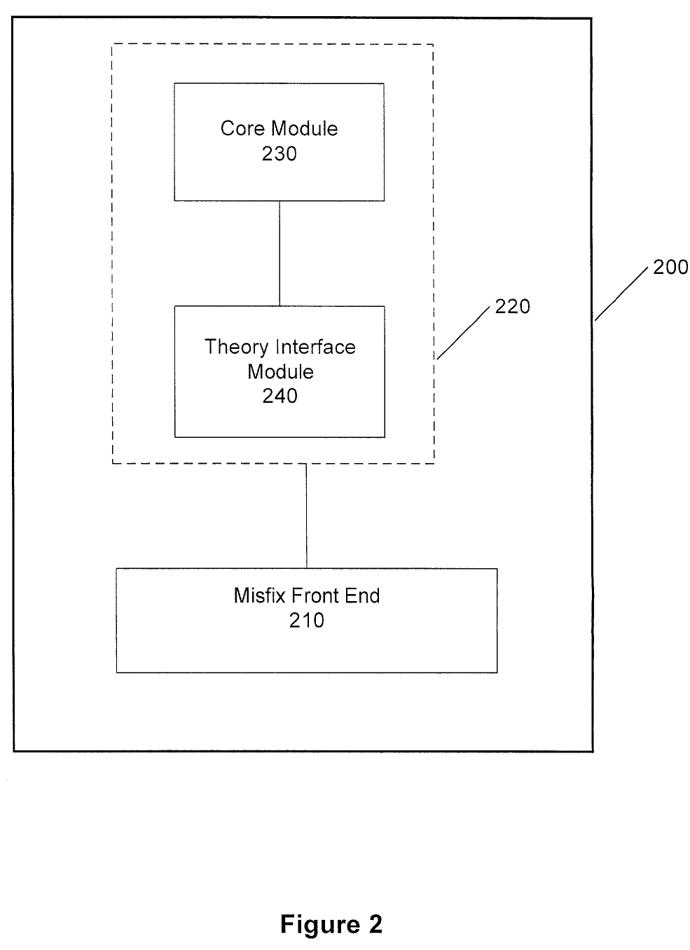

Referring to FIG. 2, the Maude system includes features build around a Maude interpreter 200. The interpreter 200 is implemented in C++ and has two principal components: the rewriting engine 220 and the mixfix front end 210.

The rewriting engine is modular and includes two key components: the core module 230 and the interface module 240. The core module 230 includes classes for objects, not specific to an equational theory, such as equations, rules, sorts, and connected sort components. “Sorts” and “subsorts” are datatypes that can be hierarchically related. The core module can implement substitutions of symbols, e.g., as specified by rewriting rules. The theory interface module 240 supports equational theory and includes abstract base classes, symbols, and matching automata. The engine is flexibly designed so that new symbols for special rewriting semantics can be added. The theory interface can be used for free theory, associative commutative (AC) theory, and so forth.

The mixfix front end 210 of the Maude system includes a bison/flex parser for syntax analysis, a grammar generator, a parser, a pretty printer, and a debugger.

### Prototype Verification System (PVS)

PVS is an example of a computing environment that provides mechanized support for formal specification and verification. PVS consists of a specification language, a number of predefined theories, a theorem prover, and various utilities (see, e.g., Shankar (1996) Formal Methods in Computer Aided Design (FMCAD'96, Palo Alto, Calif.), Lecture Notes in Computer Science 1166, pp. 257-264, Springer.)

PVS Language. The specification language of PVS is based on classical, typed higher-order logic. The base types include uninterpreted types, which may be introduced by the user, and built-in types, such as the Booleans, integers, reals, and ordinals; the type-constructors include functions, sets, tuples, records, enumerations, and recursively-defined abstract data types, such as lists and binary trees. Predicate subtypes and dependent types can be used to introduce constraints, such as the type of prime numbers. These constrained types may incur proof obligations during typechecking, but greatly increase the expressiveness and naturalness of specifications. In practice, most of the obligations are discharged automatically by the theorem prover. PVS specifications are organized into parameterized theories that may contain assumptions, definitions, axioms, and theorems. Definitions are guaranteed to provide conservative extension; to ensure this, recursive function definitions generate proof obligations. Inductively-defined relations are also supported. PVS expressions provide the usual arithmetic and logical operators, function application, lambda abstraction, and quantifiers, within a natural syntax. Names may be freely overloaded, including those of the built-in operators such as AND and +. Tabular specifications of the kind advocated by Parnas are supported, with automated checks for disjointness and coverage of conditions. An extensive prelude of built-in theories provides hundreds of useful definitions and lemmas; user-contributed libraries provide many more.

PVS Theorem Prover. The PVS theorem prover provides a collection of powerful primitive inference procedures that are applied interactively under user guidance within a sequent calculus framework. The primitive inferences include propositional and quantifier rules, induction, rewriting, and decision procedures for linear arithmetic. The implementations of these primitive inferences are optimized for large proofs: for example, propositional simplification uses binary decision diagrams (BDDs), and auto-rewrites are cached for efficiency. User-defined procedures can combine these primitive inferences to yield higher-level proof strategies. Proofs yield scripts that can be edited, attached to additional formulas, and rerin. This allows many similar theorems to be proved efficiently, permits proofs to be adjusted economically to follow changes in requirements or design, and encourages the development of readable proofs. PVS includes a BDD-based decision procedure for the relational mu-calculus and thereby provides an experimental integration between theorem proving and model checking.

PVS Interface. PVS uses Gnu or X Emacs to provide an integrated interface to its specification language and prover. Commands can be selected either by pull-down menus or by extended Emacs commands. Extensive help, status-reporting and browsing tools are available, as well as the ability to generate typeset specifications (in user-defined notation) using LaTeX. Proof trees and theory hierarchies can be displayed graphically using Tc1/Tk.

Applications of PVS. PVS can be used for the formalization of requirements and design-level specifications, and for the analysis of intricate and difficult problems, e.g., for testing algorithms and architectures for fault-tolerant flight control systems, hardware systems, and real-time system design (see, e.g., Srivas et al. (1998) Chapter 4 of Formal Hardware Verification: Lecture Notes in Computer Science, T. Kropf (ed.), Vol 1287, pp. 156-205, Springer Verlag. The PVS language and environment can be used to test specifications of biological networks, and even to design biological circuits, e.g., in combination with genetic engineering techniques.

### Symbolic Representation of Elements of Biological Systems

Models of biological systems can include symbols representing a diverse variety of elements. Some key elements are macromolecular polymers such as polypeptides and nucleic acids. Ribonucleic acids can include messenger RNAs (mRNAs), introns, tRNAs, viral RNA genomes, catalytic RNAs (e.g., ribosomal RNAs, snRNAs, and artificial ribozymes), and exogenously supplied RNAs (e.g., double stranded RNAs). Deoxyribonucleic acids can include genomic nucleic acids such as chromosomal, mitochondrial, and chloroplast nucleic acids, and extrachromosomal nucleic acids such as episomes (e.g., plasmids and other exogenously supplied nucleic acids). Elements can also refer to the different nucleic acid sequences such as coding regions, regulatory regions (e.g., promoters, enhancers, 5′ untranslated regions, 3′ untranslated regions, and internal ribosome entry sites), insulators, telomeres, centromeres, satellite repeats and so forth.

Each nucleic acid and polypeptide can also be modified by information about its sequence, e.g., whether the element is wild-type or a mutant or whether the element is associated with a biallelic marker or single nucleotide polymorphism (SNP).

Other elements can include small molecules such as metabolites, cofactors, drugs, toxins, and hormones. Small molecules are typically compounds with a molecular weight of less than 5,000 Daltons. Each molecule may also have a variety of states, e.g., oxidized or reduced. Small molecules can also include ions (e.g., calcium, sodium, potassium, chloride, and acetate), cofactors, metabolites, second messengers (e.g., cyclic AMP and phosphoinositides), and exogenous agents such as drugs, therapeutic polypeptide (e.g., therapeutic antibodies), peptide nucleic acids (PNA), and toxins (e.g., carcinogens).

Also represented are complexes of components (e.g.,the product of binding of one protein to another, of a chemical (e.g., a drug, a substrate, or an allosteric regulator) to a protein, and of a nucleic acid to a protein), modification states of components (e.g., proteins, RNA, and DNA), conformations of components (e.g., open/closed state of an ion channel, or active/inactive state of an enzyme), and the oligomerization states of a components (e.g., polymerization state of actin and microtubules).

A predicate is a function taking zero or more arguments and producing either true or false. One example of a predicate, is Aristotle's use of Mortal? as a predicate when reasoning about “all men are mortal, Socrates is a man, so Socrates is mortal”. Some predicates useful for symbolic representations of biological systems include individual properties of molecules (such as the ubiquitination state of protein or the methylation state of a gene promoter), properties of protein complexes, and properties of entire organelles, cells, tissues, and organisms.

Components can also be compartmentalized to different physical regions of the system. For example, symbols can refer to elements from particular subcellular organelles, such as the endoplasmic reticulum, Golgi, lysosome, mitochondria, plasma membrane, chloroplast, and nucleus. Some symbols describe extracellular components, e.g., components in the extracellular matrix, interstitial fluid, blood, serum, lymph, or on adjacent cells. In systems that model a plurality of cells, symbols can also be associated with a particular cell of the plurality.

Components can be compartmentalized or localized by association with another component. For example, some polypeptides are bound to polypeptide scaffolds, an actin cytoskeletal element, a microtubule cytoskeletal element, a transmembrane receptor, or molecular machine such as a proteasome. See also “Protein-Protein Interaction Maps,” below. These relationships can be represented symbolically.

Symbols can also characterize the physical properties of a biological system, e.g., hydrostatic pressure, osmotic pressure, other gradients, which can be represented as symbols. For example, pressure can be described as high, normal, or low. Additional physical parameters include ion concentration, membrane polarization (e.g., charge), membrane permeability, membrane fluidity, membrane/vesicle trafficking, pH (e.g., vesicle pH), oxidative environment, and temperature (e.g., heat shock, cold shock, or normal). pH can be described as acidic, basic, or neutral.

Modules can be created that define related groups of symbols. A module can optionally include data typing, so as to hierarchically relate components of the systems. The definitions allow the symbol parser to read, write, and process symbols. Once generated, modules can be reused for implementations of different biological systems. Custom modules can be made for particular groups of elements that may be new or unique to a system of interest. Typically, the symbols are typographical strings of characters that are easily recognizable acronyms of the names of the elements that they represent. Thus, the input and output from the models are easily understood by users as well as by the language interpreter, e.g., Maude's context-free parser. However, less convenient symbols can also be used. For example, if the user does not have to manipulate the symbols, but uses a graphical interface for interacting with the computer system, the typographical rendering of the symbols is of little import.

Symbols are used in statements about the systems. Examples of statements include rules (particularly rewriting rules), axioms, and equations.

### Rules

Rules can be generated from direct experimental observation, inference, analysis of scientific literature, available diagrams (e.g., wiring diagrams and interaction maps) of biological systems, and curated and/or annotated knowledge-bases. Knowledge of these interactions can be curated and used to render detailed representations of the molecular networks in cells. Such efforts are providing a holistic understanding of molecular interactions (see, e.g., Karp et al. (2000) Nucl Acids Res 28:56-59 and Weng et al. (1999) Science 284:92-96). A “wiring diagram” or “interaction map” for a biological system can be assembled from analysis of the scientific literature and/or collation of results from experiments (Kohn (1999) Mol. Biol. of the Cell 10:2703-2734 and Example, below). For example, the experiments can be the result of genetic analysis, e.g., phenotypes and genotypes, and biochemical experiments, e.g., physical interactions and reaction assays.

Generally, rules can be formulated based on the net effect of an interaction. Some examples are listed in Table 1 below.

TABLE 1

| Molecular Relationship | Rewriting Rule | |
|---|---|---|
| protein A causes synthesis of protein B | A → | A B |
| protein A destroys protein B | A B → | A |
| protein A activates protein B | A B → | A B: active |
| protein A inactivates protein B | A B: active → | A B |
| protein A and C activate protein B | A C B → | A C B: active |

Further guidance is also available from the specific Examples.

Conditional rules are used to express a substitution of symbols that only occurs when a condition is met. The condition can be expressed as an “if” statement. The “if” statement is evaluated first, and, if true, the rewriting rule is performed.

The use of typing enhances the capacity and expressiveness of rewriting rule statements. For example, if proteins M and N are of type A, then the rewriting rule A→A B is evaluated as follows:

given “M”, the rewriting rule produces “M B”;

given “N”, the rewriting rule produces “N B.” Thus, symbols that are declared to be of type A (or a subtype thereof), are evaluated as A by the rule.

### Computer Systems

The formal language environments described here are not limited to any particular hardware or software configuration as they can find applicability in any computing or processing environment. They can be implemented in hardware, software, or a combination of the two. They can be generated using a high level procedural language, object oriented programming language, or another formal language to communicate with a machine system. However, the programs can also be implemented in assembly or machine language, if desired. Each such program may be stored on a storage medium or device, e.g., compact disc read only memory (CD-ROM), hard disk, magnetic diskette, or similar medium or device, that is readable by a general or special purpose programmable machine for configuring and operating the machine when the storage medium or device is read by the computer to perform the procedures described in this document. The storage medium can be also be made accessible across a computer network, e.g., the Internet.

User Interfaces. The formal language environment can feature one or more communications interfaces for accepting input and sending output from a user. The user interface can be text-based and can include a text editor such as Emacs. The user interface can also be a graphical interface that facilitates user interaction with the language environment. For example, user interfaces can be deployed that allow the user to model and analyze biological systems without awareness of the underlying symbolic representations and operations. Icons for various biological elements can be displayed on a console. The user can use a mouse to connect interacting elements and to generate rules, e.g., by selecting from pop-up menus for possible outcomes of the interaction. The interface translates such user selections into a rewriting rule.

In another example, wiring diagrams are used to display information generated by the system. The term “wiring diagram” refers to a graphic having points, each representing an element of a system and lines interconnecting the points on the basis of relationships between the elements. For example, the computer system can include a monitor that displays a wiring diagram with points on the wiring diagram corresponding to symbols representing biological elements. Lines between the points correspond to rules that interrelate the biological elements.

The user can create and select lines and connection points with a mouse and move connection points in order to formulate rules. The wiring diagram can also be used to display the output of a rewrite process. Points corresponding to symbols present in the output state can be displayed with one color, whereas symbols absent in the output state can be displayed with another color. When the rewrite process detects multiple alternative states, symbols present in all alternative states can be displayed with one color, symbols absent from all alternative states can be displayed with another color, and symbols whose presence or absence varies among the alternative states can be displayed with a third color. Thus, the user is graphically conveyed an image of the biological system after the rewrite process. For example, if an entire arm of one pathway is activated, this would be readily apparent as a region of uniform color on the part of the monitor occupied by the particular branch of the pathway. Lines can be visually rendered according to whether rewriting rules were utilized in a given simulation. Further, the theorem prover and other tools can indicate which rewriting rules are true given certain input states.

Other Interfaces. In another example, the computer system is outfitted with an automated crawler for searching and scanning information databases, such as abstracts in PubMed. The crawler can be programmed to identify certain key words, e.g., “phosphorylate,” “ubiquitinate,” or “secrete,” in order to identify information about the relationship of biological elements. An intelligent parser is then used to generate rules from the identified text.

In still another example, the computer is interfaced with annotated databases that catalog biological elements and pathways. Examples of such databases include EcoCyc and Kegg (see below). The interface can interpret tags and fields from the database and translate the information into rewriting rules.

Stored Models. The invention also features machine-readable memory for storing information for models of biological systems. The information can include: modules, e.g., defining symbols, typing and membership for the biological systems; rules, e.g., rewriting rules for the biological systems; and/or state information, e.g., collections of symbols defining one or more biological states. The memory store can optionally also contain a variety of other information such as hyperlinks, e.g., connecting a rule to a file with pertinent information such as raw experimental data or a scientific reference. The information can pertain to a single biological system or multiple systems.

Inference Methods. The invention also features the efficient manipulation of symbolic abstractions of biological systems. The algorithms employed include Decision Diagrams (e.g., as described in Bryant, R E (August 1986) “Graph-Based Algorithms for Boolean Function Manipulation”, Transactions On Computer, Vol. C-35: 677-691), which allow efficient representation of many logical functions. For many problems, Decision Diagrams provide an exponential advantage in representation and manipulation efficiency over naive conjunctive or disjunctive normal form. The algorithms employed include transitive closure of hypergraphs. Transitive closure of hypergraphs representing biological problems can be accomplished in many cases with iterative doubling of the graph structure. In some cases this can provide exponential efficiency improvement. The algorithms employed include lattice-based representation and manipulations of states.

Biological systems can also be represented using vectors of Boolean, discrete, or continuous values with significant efficiency gains in some cases.

### System States

The state of a biological system is described using declared symbols. The symbols can describe the presence or absence of a component and provide descriptive information about a component, such as modification state, conformation, and localization.

State information can be assembled by a user, e.g., to supply an inference engine with information about a hypothetical starting state. State information is also generated as output by the inference engine, e.g., in the form of a terminal state or alternative resultant states. The input and output states can represent any possible state for a biological system. Some non-limiting examples of such states include a differentiated state, a quiescent state, a dividing or proliferative state, a diseased state, an injured state, an apoptotic state, a mutated or genetically predisposed state, an infected state, and an immune-compromised state.

The information about the state of a biological system can be assembled from a variety of sources including high-throughput bioinformatics tools.

### Informatics

High-throughput tools can be used analyze a whole genome and/or proteome. Such analysis can generate a large volume of data. Tools for such analysis are described below. Particularly useful data sets include gene expression profiles, polypeptide profiles, and protein interaction maps. “Profiles” are data records that include values or descriptors for multiple biological elements, e.g., genes or polypeptides. For example, a “gene expression profile” can include qualitative or quantitative information about the level of expression of a plurality of genes. A “polypeptide profile” can include qualitative or quantitative information about the abundance and/or modification state of a plurality of polypeptides. Profiles can provide an extensive description of the state of a cell. Qualitative or quantitative profile information can be translated into symbolic form and interpreted by an inference engine.

### Gene Expression Profiles

Information about the expression level of multiple genes can be rapidly obtained using arrays of nucleic acid capture probes (see, e.g., Schena (1995) Science 270:467; Iyer et al. (1999) Science 283:83; DeRisi et al. (1997) Science 278:680; Lockhart and Winzeler (200) Nature 405:827; Cho et al. (2001) Nature Genetics 27:48). Arrays contain multiple addresses, each dedicated to detecting the presence of a particular transcript. The abundance of thousands of transcripts in one or many samples can be detected.

Arrays can be fabricated by a variety of methods, e.g., photolithographic methods (see, e.g., U.S. Pat. Nos. 5,143,854; 5,510,270; and. 5,527,681), mechanical methods (e.g., directed-flow methods as described in U.S. Pat. No. 5,384,261), pin based methods (e.g., as described in U.S. Pat. No. 5,288,514), and bead based techniques (e.g., as described in PCT US/93/04145). The capture probe can be a single-stranded nucleic acid, a double-stranded nucleic acid (e.g., which is denatured prior to or during hybridization), or a nucleic acid having a single-stranded region and a double-stranded region. Preferably, the capture probe is single-stranded. The capture probe can be designed, e.g., by a computer program, to satisfy a variety of criteria. The capture probe can be selected to hybridize to a sequence rich (e.g., non-homopolymeric) region of the nucleic acid. The Tₘ of the capture probe can be optimized by prudent selection of the complementarity region and length, e.g., such that the Tₘ's of all capture probes on the array are similar. A database scan of available sequence information for a species can be used to determine potential cross-hybridization and specificity problems.

The isolated nucleic acid is preferably mRNA that can be isolated by routine methods, e.g., including DNase treatment to remove genomic DNA and hybridization to an oligo-dT coupled solid substrate (e.g., as described in Current Protocols in Molecular Biology, John Wiley & Sons, N.Y). The substrate is washed, and the mRNA is eluted.

The isolated mRNA can be reverse transcribed and optionally amplified, e.g., by rtPCR, e.g., as described in (U.S. Pat. No. 4,683,202). The nucleic acid can be an amplification product, e.g., from PCR (U.S. Pat. No. 4,683,196 and 4,683,202); rolling circle amplification (“RCA,” U.S. Pat. No. 5,714,320), isothermal RNA amplification or NASBA (U.S. Pat. Nos. 5,130,238; 5,409,818; and 5,554,517), and strand displacement amplification (U.S. Pat. No. 5,455,166). The nucleic acid can be labeled during amplification, e.g., by the incorporation of a labeled nucleotide. Examples of preferred labels include fluorescent labels, e.g., red-fluorescent dye Cy5 (Amersham) or green-fluorescent dye Cy3 (Amersham), and chemiluminescent labels, e.g., as described in U.S. Pat. No. 4,277,437. Alternatively, the nucleic acid can be labeled with biotin, and detected after hybridization with labeled streptavidin, e.g., streptavidin-phycoerythrin (Molecular Probes).

The labeled nucleic acid can be contacted to the array under hybridization conditions. The array can be washed, and then imaged to detect fluorescence at each address of the array. The extent of hybridization at an address is represented by a numerical value and stored, e.g., in a database record (e.g., a table row), a vector, a one-dimensional matrix, or a one-dimensional array. For example, the database record or vector has a numerical value for each address of the array. The numerical value can be adjusted, e.g., for local background levels, sample amount, and other variations. Further a nucleic acid can also be prepared from a reference sample and hybridized to an array (e.g., the same or a different array). The sample expression profile and the reference profile can be compared, e.g., using a mathematical equation that is a function of the two vectors. The comparison can be evaluated as a scalar value, e.g., a score representing similarity of the two profiles. Either or both vectors can be transformed by a matrix in order to add weighting values to different nucleic acids detected by the array.

The expression data can be stored in an expression profile database, e.g., a relational database such as a SQL database (e.g., Oracle or Sybase database environments). The database can have multiple tables. For example, raw expression data can be stored in one table, in which each column corresponds to a nucleic acid being assayed, e.g., an address or an array, and each row corresponds to a sample. A separate table can store identifiers and sample information, e.g., the batch number of the array used, date, and other quality control information.

The similarity of a sample expression profile to a predictor expression profile (e.g., a reference expression profile that has associated weighting factors for each nucleic acid) can then be determined, e.g., by comparing the log of the expression level of the sample to the log of the predictor or reference expression value and adjusting the comparison by the weighting factor for all nucleic acids of predictive value in the profile.

Store or analyzed gene expression data is then used to specify the state of a cell. For example, each gene element in a model can be assigned a state, e.g., “on” or “off.” The determination of whether a gene is “on” or “off” can be made by a variety of statistical methods. For example, a numeric value for expression can be compared to the background detection values for genes known to be “off,” or for negative controls. In another example, a numeric value for expression is compared to a corresponding value in a reference data set. Expression information can be also categorized by predicates, e.g., to categorize expression of a nucleic acid as “activated,” “basal,” or “repressed.”

### Regulatory Sequences

In addition to providing information about the expression level of genes, gene profiling information can be used to identify co-regulated genes. Data from different conditions is clustered to group genes that are similarly regulated in one or more samples. Such clusters are useful information for formulating rules about gene regulation. Techniques for clustering include hierarchical clustering (see, e.g., Sokal and Michener (1958) Univ. Kans. Sci. Bull. 38:1409), Bayesian clustering, k-means clustering, and self-organizing maps (see, Tamayo et al. (1999) Proc. Natl. Acad. Sci. USA 96:2907).

In one embodiment, multiple expression profiles from replicate data sets taken under different conditions are compared to identify nucleic acids whose expression level is predictive of the each condition. Each candidate nucleic acid can be given a weighted “voting” factor dependent on the degree of correlation of the nucleic acid's expression and the sample identity as described in Golub et al. ((1999) Science 286:531. A correlation can be measured using a Euclidean distance or the Pearson correlation coefficient.

Rules can be generated such that clustered genes are co-regulated in the model. For example, a rule that governs one gene of the cluster can be replicated or extended to regulate additional genes of the cluster.

Information about regulatory sequences that govern transcription of genes is also incorporated into rules. Such information can range from detailed characterization of a function of a transcription factor at a particular promoter to identification of a transcription factor binding consensus sequence in the vicinity of a gene. Information about regulatory sequences can be obtained by computer-based searches and/or biochemical experiments.

Sequence analysis programs are used to scan genomic nucleic acid sequences to identify sequences common to similarly regulated genes (see, e.g., Wolfsberg et al. (1999) Genome Research 9:755). As the binding sites can be quite small and degenerate, statistical procedures are used to enhance the search method. Identified binding sites can be correlated to a known transcription factor binding sites by querying a database of known transcription factor binding sites. Even absent such information, a rule can be generated that links coregulated genes having the same binding site.

In addition, biochemical experiments are used to identify regulatory sequences. For example, Ren et al. ((2000) Science 290:2306) monitored the location of DNA binding proteins throughout the yeast genome. DNA binding proteins were crosslinked to nucleic acid with formaldehyde; the DNA was fragmented by sonication, and bound fragments were isolated by immunoprecipitation with antibodies specific to DNA-binding proteins of interest. The crosslinks were reversed; the fragments were amplified and labeled, and hybridized to an array containing all yeast intergenic nucleic acid sequences. This technique can be used as a means for generating rules or theorems. Genes that contain a particular binding site are likely to be regulated by the polypeptide that recognizes the binding site.

### Protein-Protein Interaction Maps

Protein-protein interactions are common features of a biological system and can be central to generating a network of interactions, particularly in signaling pathways. Matrices of protein-protein interactions are available such as described in Walhout et al., Science 287: 116-122, 2000; Uetz et al., Nature 403, 623-631, 2000); and Schwikowski (2000) Nature Biotech. 18:1257. Walhout et al. identified interactions among a matrix of C. elegans vuval development signalling proteins. Uetz et al. and Schwikowski et al. identified interactions among a matrix of thousands of proteins identified in yeast. The two-hybrid assay is used to determine if one polypeptide can bind to another. Since the assay is performed in yeast cells using fusion proteins to a DNA binding domain and a transcriptional activator, each yeast strain bearing a DNA binding domain fusion can be combined with yeast strain bearing the activation domain fusion using a simple mating technique. The assay is also easily scored by assessing reporter gene transcription. Each observed protein interaction can be used to generate an interaction rule, or a testable theorem. For example, if protein A stably binds to protein B, a rewriting rule can be used to replace the instance of protein A and B with a protein complex A:B.

Interactions that are not observed can be due to failure of the assay to accurately detect a physical interaction, e.g., the assay may not identify all possible interactions for transmembrane proteins.

Interactions can be determined in a variety of conditions. For example, each protein-protein interaction can be observed in a different genetic environment, e.g., a different yeast host strain or with allelic variants of the interaction partners. Each protein-protein interaction can also be observed while the cells are exposed to an exogenous agent, e.g., a small organic compound such as a drug or drug candidate. Information about such interactions can be used to build additional rules, for example, conditional rewriting rules.

### Polypeptide Arrays

Polypeptide arrays can be used to obtain data about a cell state. Such arrays can be used to rapidly assay many different polypeptides. For example, an array can be contacted with a substrate, a ligand, or an enzyme to identify interactions.

A low-density (96 well format) protein array has been developed in which proteins are spotted onto a nitrocellulose membrane Ge, H. (2000) Nucleic Acids Res. 28, e3, I-VII). A high-density protein array (100,000 samples within 222×222 mm) used for antibody screening was formed by spotting proteins onto polyvinylidene difluoride (PVDF) (Lueking et al. (1999) Anal. Biochem. 270, 103-111). Polypeptides can be printed on a flat glass plate that contained wells formed by an enclosing hydrophobic Teflon mask (Mendoza, et al. (1999). Biotechniques 27, 778-788.). Also, polypeptide can be covalently linkled to chemically derivatized flat glass slides in a high-density array (1600 spots per square centimeter) (MacBeath, G., and Schreiber, S. L. (2000) Science 289, 1760-1763). De Wildt et al., describe a high-density array of 18,342 bacterial clones, each expressing a different single-chain antibody, in order to screening antibody-antigen interactions (De Wildt et al. (2000). Nature Biotech. 18, 989-994). These known methods and other can be used to generate an array of antibodies for detecting the abundance of polypeptides in a sample. The sample can be labeled, e.g., biotinylated, for subsequent detection with streptavidin coupled to a fluorescent label. The array can then be scanned to measure binding at each address.

### Proteomics

Proteomics includes a large set of tools for the analysis of polypeptides in a sample. These tools can be used to monitor expression level, post-translational modifications, enzymatic activity, protein-protein interactions, and evolutionary relationships.

Additional sources for rules include computational methods for identifying interactions between elements of biological systems. Examples of such methods include the comparative genome and phylogenetic analysis described in Pellegrini et al. (1999) Proc. Natl. Acad. Sci. USA 96:4285 and Marcotte et al. (1999) Nature 402:83. Interactions predicted by computational methods can be verified using a theorem prover.

### Mass Spectroscopy

Mass spectroscopy can be used to obtain accurate analysis of the identity and/or modification state of a polypeptide species. For example, a polypeptide can be fragmented with a site-specific protease (e.g., trypsin, chymotrypsin, or subtilisin), combined with a matrix, and then excited with a laser. Its flight through the mass spectroscopy instrument is analyzed to determine its molecular weight with high accuracy. The molecular weights of proteolytic fragments provide an accurate fingerprint of the polypeptide or of a pool of polypeptides. Changes in the molecular weight of peptide fragments can be associated with post-translational modification. See, e.g., Shevchenko et al. (2000) Anal. Chem. 71:2132-2141 for a review.

Mass spectroscopy can be combined with 2-dimensional gel electrophoresis to provide a polypeptide profile of a cell or sample. Polypeptides from the cell are sample are separated in an acrylamide gel by isoelectric pont and molecular weight. Then different addresses of the gel are analyzed as described above. Information about isoelectric point, molecular weight, and proteolytic fragment sizes can be stored in database records. This information can be used to generate information about the state of a biological system. Alternatively, this information can be compared to a similar analysis of a reference sample or cell. The result of the comparison can be used to generate a profile of the polypeptides in a cell. The profile can include information such as “protein X is phosphorylated” and “protein Y is proteolytically processed.”

### Metabolic Pathways

Rules can be generated from curated information about metabolic pathways, e.g., from textbooks, experimental observations, or databases. For example, the EcoCyc database (Karp et al. (2000) Nucl Acids Res 28:56-59) is a computer database of metabolic pathways in E coli. The database includes computer-readable and portable representations (e.g., ontologies) of biological functions for nucleic acid and amino acid sequences. In one version, the EcoCyc database included 744 reactions catalyzed by 607 enzymes, many of which are multifunctional. The reactions were organized into 131 pathways. This metabolic map described 791 chemical substrates. Also included are an additional 161 reactions involving macromolecule metabolism, e.g., DNA replication and tRNA charging.

Information from the database can be translated into symbols and imported into a rule generator.

The database includes entries for components and steps of pathways, e.g., a metabolic pathway that includes a step for converting metabolite X into metabolite Y using enzyme Z. Such a conversion can be expressed by the following rewriting rule:

XZ→YZ.

Other databases of metabolic and signaling pathways include the WIT server (http://www-unix.mcs.anl.gov/compbio/), and KEGG (Ogata et al. (1998) BioSystems 47:119; http://www.genome.ad jp/kegg/).

### Uses

The models, theorem provers, and inference engines described here are versatile tools for the analysis of biological systems. Non-limiting examples of their use include the generation of testable hypotheses, identification of drug targets, engineering biological circuits, diagnostics, and education.

The models can be of biological systems of any species of life, particularly, of human, mouse, rat, Drosophila melanogaster, Caenorhabditis elegans, Danio rerio, Arabidoposis thaliana, Oryza sativa, Zea mays, Saccharomyces cerevisiae, Escherichia coli, Salmonella typhimurium, and Mycoplasma genitalium.

Mycoplasina genitalium is notable as being one of the simplest cellular life forms. The 580 kilobase genome of Mycoplasma genitalium was determined (Fraser et al. (1995) Science 270:397). The genome encodes only 480 polypeptide species, and 37 RNA species. By transposons mutagenesis, Hutchison et al. ((1999) Science 1286:2165) have determined that only 265 to 350 of these genes are likely to be essential for supporting life. This genetic information and information from on-going efforts to characterize the genes of this minimalist system can be used as a prototypic model for a biological model of a cell. Rules and inferences obtained from this model can also be applied to models of more complexes systems. Also an animated model based on a rule set for Mycoplasma genitalium can be used as an interactive educational tool

### Hypothesis Generation

In one exemplary application of the methods described here, rules and a hypothetical input state of a biological system are processed by an inference engine. The engine identifies one or more resultant states. Each of these resultant states can regarding as a testable hypothesis. An experimentalist can verify such results using a laboratory model of the biological system. The results of the laboratory experiments can be used to develop additional rules about the system. For example, the results can be fed into an inference engine, e.g., along with previous information, to obtain possible resultant states. If the experimental results are able to differentiate between the previous set of resultant states, this second implementation of the inference engine results in fewer alternative resultant states. This cycle of hypothesis generation and testing can be repeated until only one or a select few alternative resultant states are identified.

In addition, results from experimental tests can be used by theorem prover functions of the inference engine in order to identify and/or test new rules. Thus, each additional experimental result produces additional rules that describe the system.

Further, the inference engines described here can be used to identify the properties of rules sets. For example, the rules can be analyzed to determine if they are terminating and/or if they are Church-Rosser. Such analysis can be useful for identifying intricate feedback and feedforward loops, e.g., such loops may not be readily apparent from a wiring diagram.

### Diagnostics

The methods described here can also be used in diagnostic applications. Information about a sample from a patient is used to supply an initial state for the inference engine. The information can include information about gene expression, polypeptide modification state, and genetic variations. The inference engine then computes possible alternative resultant states using rules, e.g., rules pertaining to the type of tissue sample used. At least some of the rules can include relationships between genetic variations in the elements (e.g., mutations, SNPs, translocations, and trinucleotide repeats) and their function in the system. The alternative resultant states represent possible diagnoses for the patient. These alternatives can suggest additional information to supply, e.g., other symptoms, to the system in order to refine the diagnosis. In addition, complex rule sets representing rules for multiple different cell types can be used in order to model possible disorders involving multiple cell types.

For example, the models can be used to predict disorders characterized by changes in cell proliferation (e.g., cancers), cell differentiation, cell adhesion (e.g., metastatic cancers), hormone levels (e.g., metabolic and neurological disorders), and so forth.

### Drug Discovery

The methods described here can be used to identify drug targets. For example, the states of a normal and a diseased cell are compared by the inference engine. The diseased cell, such as a cancer cell, is used as an initial state for the cell system. The initial state can be generated from observations such as a gene expression profile obtained from a sample of diseased cells. The final state can be generated from similar observations of a normal cell. The methods described here are used to identify one or more elements of the diseased system that, when altered, cause the diseased state to transition to the normal state.

Such elements are potential drug targets as alteration of their state results causes the system to return to a desired state. Accordingly, a drug that similarly alters the properties of the identified element should cause the diseased cell to become normal.

### Engineering Biological Circuits

The rules can be used to design artificial regulatory circuits. Genetic engineering has been used to construct transcriptional regulatory circuits and synthetic proteins with new properties. Such circuits are useful for creating cell-based biosensors which can sense environmental changes and intelligent cell-based therapeutic delivery systems, e.g., recombinant cells producing a therapeutic polypeptide such as a humanized antibody or a polypeptide hormone.

Gardner et al. (2000) Nature 402:339) and Becskel & Serrano et al. (2000) Nature 405:590 describe the design of artificial biological circuits that function as stable genetic switches.

The design of biological circuits is facilitated by the inference engines and methods described here since these tools can be used to identify rules that are necessary for a contemplated circuit. The user can then construct the necessary recombinant molecules to implement the rule. Such recombinant molecules can include chimeric signaling molecules (e.g., ones that fuse an adaptor from one pathway with an enzyme of another pathway), chimeric transcription regulatory sequences (e.g., combinations of binding sites for different transcriptional regulators), chimeric transcription factors, and artificial promoters.

Alternatively, the methods described here are used to test whether a contemplated circuit would function as designed. Rules are generated based on the circuit design and are supplied to an inference engine in combination with one or more hypothetical initial state. The outcome of the circuit is vigorously simulated under a variety of conditions to determine if it is operating as expected before implementation.

### Pathogens

The interaction of a pathogen with its host provides an additional example of the diagnostic and analytic application of the methods described here. Rules that describe the circuitry of pathogen molecules are combined with rules that describe the circuitry of host cells to model pathogenic events. Examples of pathogens suitable for this analysis include viruses (e.g., retroviruses such as HIV, DNA-tumor viruses, adenoviruses, herpes viruses, and bacteriophages, bacteria such as Gram-negative and Gram-positive bacteria, protists such as Plasmodium falciparum, fungi, and metazoans (e.g., filarial nematodes).

The model of host and pathogen can be used to identify key host and pathogenic elements which are potential drug targets. Further, the system can be analyzed to identify host cell states that require the presence of a pathogen. Such host cell states are used as references in diagnostic tests for determining if a pathogen is present or active.

In viruses, the host and pathogen are particularly intimately associated as the virus enters cells and utilizes host cell factors. Rules can for example test for the presence of appropriate cell surface receptors and co-receptors for viral entry. In addition, the cell has its own response to invasion. Double-stranded RNA, for example, is detected and activates dsRNA-dependent kinase and subsequent signaling events. Such signals can result in interferon-γ production. Rules describing additional cells such as immune cells can also be included.

### Some Illustrative Signaling Elements

Many cellular signaling networks feature the sensing of an extracellular signal, the activation of a cytoplasmic sequence of signaling events (such as a cascade of kinase activation), and the regulation of gene transcription.

Kinase cascades. The presence of an extracellular signal frequently elicits the activation of an intracellular kinase cascade. For example, the binding of BDNF factor to its receptor, a tyrosine kinase receptor, activates binding of the adaptor molecule GRB2 to the receptor. GRB2 recruits the guanine nucleotide exchange factor (GEF) Sos to the complex. Sos causes the guanine nucleotide binding protein, Ras, to release GDP and bind GTP. The GTP bound state of Ras activates the serine-threonine kinase Raf. Raf activates the kinases MEK1 and MEK2, which activate the MAPKK (MAP kinase kinases), which activate MAP kinases 1 and 2. MAP kinases 1 and 2 phosphorylate the transcription factor Elk-1, thus causing changes in gene regulation

Transcription Factors. Many well characterized transcriptional factors and their nucleic acid binding sites function as signal integrators.

For example, interferon-β gene is activated by three polypeptides, ATF-2, NF-κB, and IRF-1, in response to viral infection. Double-stranded RNA from the infecting virus separately triggers each of the transcription factors. However, to insure the fidelity of the response, all three factors must be active for transcription to ensue. The biochemical basis for this switch is a synergistic binding of the polypeptides to a segment of the promoter (reviewed in Maniatis et al. (1992) In Transcriptional Regulation Vol. 2, pp. 1193-1220 Cold Spring Harbor Press, Cold Spring Harbor N.Y.). Although each polypeptide alone can bind weakly to the segment, protein-protein interactions among the three result in highly cooperative binding (Du et al. (1993) Cell 74:887; Thanos and Maniatis (1995) Cell 83:1091). This example is illustrative of the role of information about physical interactions such as protein-protein interactions and protein-nucleic acid interactions in modeling a system. This system can be modeled as a rewriting rule that replaces activated ATF-2, NF-κB, and IRF-1 with interferon-β.

Another gene that processes two independent signals at its promoter is the lac operon of E. coli. The lac operon which includes the lacZYA genes of E. coli is only transcribed in the presence of lactose and the absence of glucose. Either condition alone does not suffice. In the absence of lactose, the lac repressor inhibits lac transcription by preventing clearance of RNA polymerase (Gralla (1992) In Transcriptional Regulation Vol. 2, pp. 629-642 Cold Spring Harbor Press, Cold Spring Harbor N.Y.). In the presence of lactose, an inducer, allolactose, which is a secondary metabolite from lactose, binds to the lac repressor and decreases its affinity for DNA. However, loss of lac repressor binding is not sufficient for lac operon transcription. The cap activator protein must be activated by cAMP, a small molecule indicator for the absence of glucose.

The spatial and temporal regulation of stripes of gene expression in the Drosophila embryo is also the manifestation of the cell's ability to process complex rules. The even-skipped segmentation gene is controlled by multiple enhancer regions, each directing expression of a stripe of gene expression. The eve stripe 2 enhancer (Arnosti et al. (1996) Development 122:205) is a 500 basepair DNA site which binds multiple factors, including Bicoid and Hunchback, which together activate the promoter, and Giant and Kruppel which repress the promoter. The cells of stripe 2 are located in a zone of high Bicoid activity, a morphogen present at high concentrations at the anterior of the embryo. The front border of the stripe 2 enhancer, in contrast is the result of repression by anterior stores of the Giant repressor. The posterior edge is limited by Kruppel expression. Thus, the convergence of multiple transcription factors on a regulatory element of a promoter generates a spatially restricted pattern of gene expression. The combinatorial control by these various factors can be implemented as a rewriting rule of the biological system.

Neuromuscular Junction. Interactions between cells can be modeled. For example, the interactions between a neuron and a muscle cell at neuromuscular junctions are precisely regulated. The interactions include the arrival of an action potential in the axon of the neuron at the synapse. This action potential can open voltage gated Ca²⁺ channels. The Ca²⁺ signal can trigger synaptic vesicle membrane proteins to interact with plasma membrane proteins in order to cause the release of neurotransmitters, such as acetylcholine, in the synaptic vesicle into the synapse. The muscle cell has surface receptors for the neurotransmitter. The acetylcholine receptor is a ligand-gated ion channel that has an open and closed conformation. The binding of acetylcholine to the receptor triggers a conformational change from closed to open, thus allowing small cations to enter the muscle cell and depolarize the membrane. This generates a propagating action potential in the muscle cell that results in muscular contraction.

Additional mechanisms operate to desensitize and or reset the system. Acetylcholinesterases in the cleft inactivate and destroy the secreted acetylcholine. In another adaptive response, Ca²⁺ open channels that let potassium ions enter the axon and terminate Ca²⁺ influx, thus ending the action potential.

### EXAMPLE

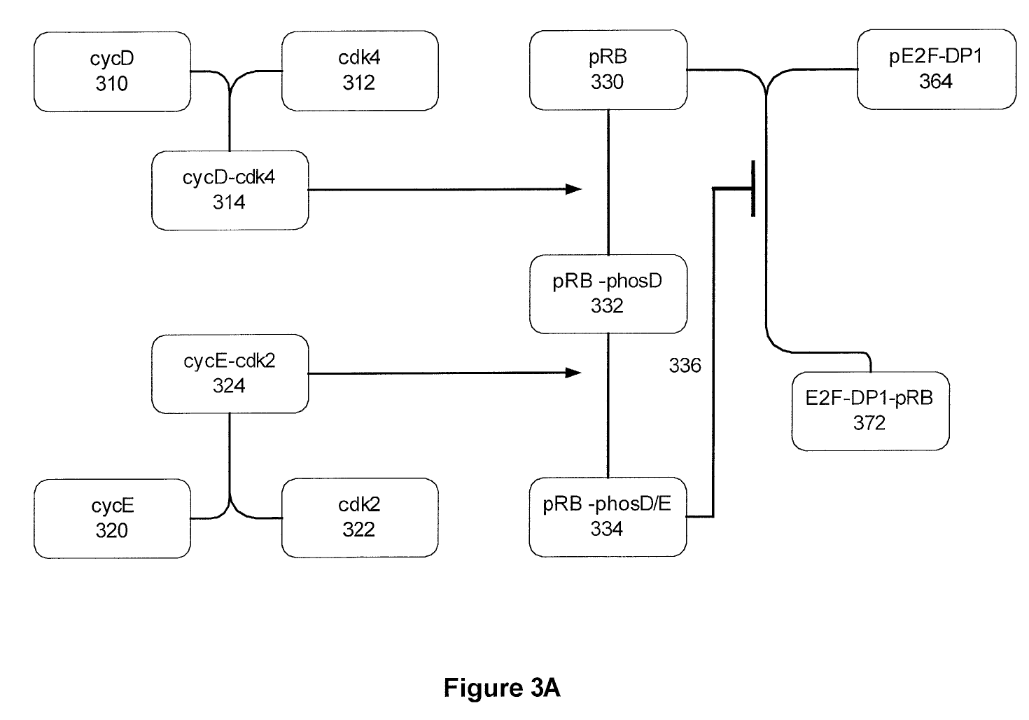

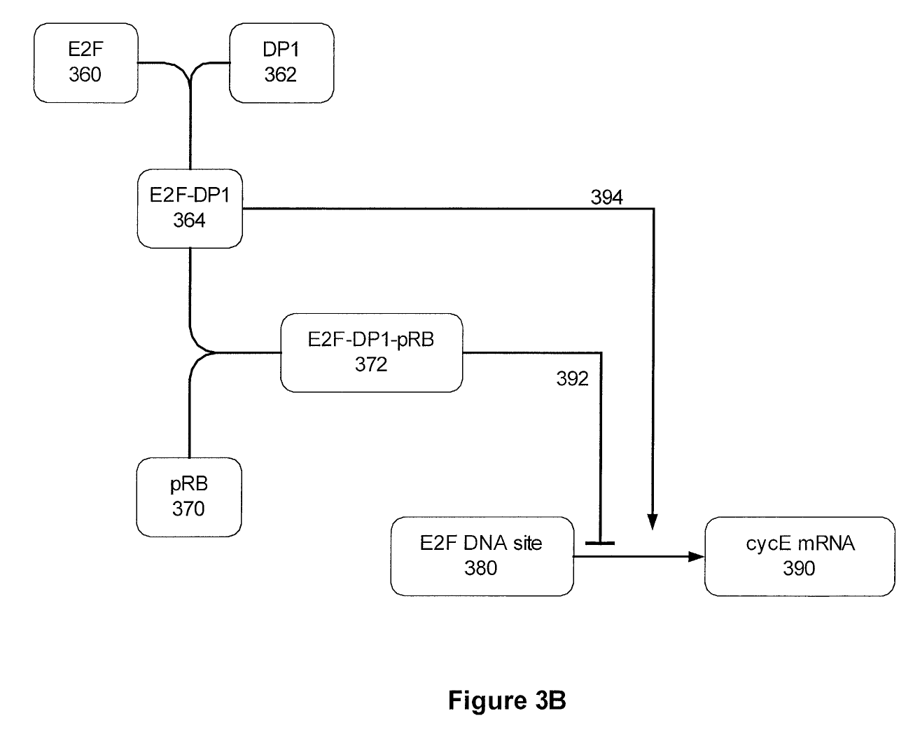

The Maude language was used to model the control of the tumor suppressor protein pRB and its interactions with associated cell-cycle regulators, cycD, cycE, cdk4, cdk2, E2F1, and DP1. Such interactions are depicted in the wiring diagrams of FIG. 3A and 3B. Kohn ((1999) Mol. Biol. of the Cell 10:2703-2734) provided similar wiring diagrams of a cell cycle regulatory network that includes these components. The Kohn map is a synthesis of numerous published experimental results. Indicated on the map are multiprotein complexes, gene promoters, DNA damage events, enzymes, e.g., DNA repair enzymes, and DNA modification enzymes.

The Appendix of U.S. Provisional Application No. ______, filed May 10, 2001, titled “Modeling Biological Systems,” naming Patrick D. Lincoln and Keith R. Laderoute as inventors, provides an example of Maude code for modeling cellular behavior.

Components of the cell-cycle regulation system were first defined using hierarchical types. What follows is an example of Maude code for declaring symbols for this biological system:

TABLE 2
Maude Code Declaring General System Components

fmod MODIFICATION is

pr MACHINE-INT .
sorts Site Modification ModSet AminoAcid Protein .
subsort Modification < ModSet .
ops glycine alanine valine leucine isoleucine proline : −> AminoAcid .
ops serine threonine cysteine methionine asparagine : −> AminoAcid .
ops glutamine phenylalanine tyrosine tryptophan lysine : −> AminoAcid .
ops arganine histidine asparate glutamate selenocysteine : −> AminoAcid .
op AminoAcidSite : AminoAcid MachineInt −> Site .
op phos : Site −> Modification .
op acetyl : Site −> Modification .
op ubiq : Site −> Modification .
op none : −> ModSet .
op _ : ModSet ModSet −>ModSet [assoc comm id: none] .
op _contains_ : ModSet Modification −> Bool .
var M M′ Modification .
var MS : ModSet .
eq none contains M′ = false .
eq (M MS) contains M′ = if M == M′ then true

else MS contains M′ fi .

endfm
fmod PROTEIN is

pr MODIFICATION .
sort Protein .
op [_ | _] Protein ModSet −> Protein [right id: none] .

endfm
fmod COMPLEX is

pr PROTEIN .
sort Complex .
subsorts Protein < Complex .
op _ :_ : Complex Complex −> Complex [comm] .

endfm
fmod SOUP is

pr COMPLEX .
sort Soup .
subsort Complex < Soup .
op _ : Soup Soup −> Soup [assoc comm] .

endfm

The first module (MODIFICATION) declares symbols of the type “Site” “Modification” “ModSet” “AminoAcid” and “Protein”. “Modification” is a type of “ModSet”. These symbols are generally useful for describing proteins and features of their sequence, particularly amino acid modifications.

“AminoAcid” can be any of the twenty amino acids.

“AminoAcidSite” is a type that is classified as a “Site” that has an amino acid and an integer (MachineInt) associated with it.

Next, three different post-translational modifications are declared: “phos” for phosphorylation, “acetyl” for acetylation, and “ubiq” for ubiquitination.

The next module (PROTEIN) declares an operator that predicates protein symbols with modifications.

The module (COMPLEX) declares the sort “Complex.” For convenience, a protein, e.g., a monomer protein, is also declared as a “Complex,” i.e., a complex of one species. The operator having a colon (“_:_”) is defined, such that A:B refers to a complex of A and B. This operation is commutative.

The module (SOUP) was similarly constructed and refers to an environment having multiple complexes.

TABLE 3
Maude Code Declaring Cell Cycle Control Elements

mod K5 ls

inc SOUP .

*** constants to represent unmodified proteins

ops cycD cycE cdk4 cdk2 pRb E2F1 DP1 : −> Protein .

*** [1] Cyclin D binds to Cdk4 forming the complex CycD:Cdk4

r1 cycD cdk4 => cycD : cdk4 .

*** [2] Cyclin E binds to Cdk2 forming the complex CycE:Cdk2

r1 cycE cdk2 => cycE : cdk2 .

*** [3] CycD:Cdk4 phosphorylates pRb at site D

op D : −> Site .
r1 pRb (cycD : cdk4) => [pRb | phos(D)] (cycD : cdk4) .

*** [4] CycE:Cdk2 phosphorylates pRb-P(D) at site E.

op E : −> Site .
r1 [pRb | phos(D)] (cycE : cdk2) =>
[pRb | phos (D) phos (E)] (cycE : cdk2) .

*** [5] E2F1 binds to DP1

r1 E2F1 DP1 => E2F1 : DP1 .

*** [6] Fully phosphorylated pRb cannot bind to E2F1:DP1

var M : ModSet .
crl [pRb | M] (E2F1 : DP1) => [pRb | M] : (E2F1 : DP1)

if not((M contains phos(D)) and (M contains phos(E))) .

endm
rew
cycD cycE cdk4 cdk2 pRb E2F1 DP1
***

| | |
|---|---|
| *** | Regulation of G1-S transition |

***
mod G1S is

inc SOUP .

*** [7] constants to represent unmodified proteins

ops cycD cycE cdk4 cdk2 pRb E2F1 DP1 : −> Protein .
sorts Signal MitogenicSignal SPhaseEntrySignal .
subsorts MitogenicSignal SPhaseEntrySignal < Signal .

*** [8] Signals are Declared

subsort Signal Complex .
op TGFbeta : Signal .
op replicate′ : −> MitogenicSignal .
op entersphase! : −> SPhaseEntrySignal .
var MITOGENICSIGNAL : MitogenicSignal .
sorts CipKip CKI .
subsorts CipKip CKI < Protein .
ops p21Cip1 p27Kip1 p57Kip2 : −> CipKip .
var CIPKIP : Cipkip .
ops p15 p16 ink4a ink4b : −> CKI .
var CKIv : CKI .
op D : −> Site .

*** [9] Cyclin D binds to Cdk4 forming the complex CycD:Cdk4

r1 cycD cdk4 => cycD : cdk4 .

*** [10] MitogenicSignal prods cyclin complex to sequester cipkip

r1 MITOGENICSIGNAL cycD : cdk4 CIPKIP =>

(cycD : cdk4) : CIPKIP .

*** [11] TGFbeta produces Ink4a and Ink4b

r1 TGFbeta => Ink4a Ink4b .

*** [12] ink4 ruins the big complex, marks cycD for destruction

r1 CKIv (cycD : cdk4) : CIPKIP => (CKIv : cdk4) CIPKIP [cycD : phos (D)] .

*** [13] phosphorylated cycD is destroyed

r1 [cycD : phos(D)] => cytoplasm .

*** [14] almost an identity

r1 cytoplasm cytoplasm => cytoplasm .

*** [15] cyclin E CDK2 complex is inactivated by CipKip.

r1 (cycE : cdk2) CIPKIP => (cycE : cdk2) : CIPKIP .

*** [16] CyclinD dependent kinase complex sequentially phosphorylates pRb

r1 ((cycD : cdk4) : CIPKIP) (pRb : E2F1) =>

((cycD : cdk4) : CIPKIP) [pRb | phos(D)] E2F1 .

*** [17] E2F1 activates transcription of genes for Cyclin E

r1 E2F1 => E2F1 cycE .

*** [18] E2F1 throws cell into S phase

r1 E2F1 => E2F1 entersphase! .

*** [19] Cyclin E and CDK2 form a complex

r1 cycE cdk2 => cycE : cdk2 .

endm

Rules (indicated by “rl”) were created to describe interactions among cell cycle regulatory proteins as shown above. Constants were introduced for the representation of cycD 310, cyce 320, cdk4 312, cdk2 322, pRB 330, E2F1 360, and DP1 362. Rules were used to indicate the specificity of cyclins for particular cyclin-dependent kinases: cycD 310 binding to cdk4 312, and cycE 320 binding to cdk2 322.

Cyclin D•cdk4 314 phosphorylates pRB 330 at multiple amino acid positions. Site D 332 was used to represent this group of amino acids. A rewriting rule ([3]) was formulated to indicate that if pRB and cyclin D•-cdk4 are present then site D of pRB is modified by phosphorylated. A similar rewriting rule ([4]) was generated for site E 334 phosphorylation by cycE•cdk2. This rule requires that site D is phosphorylated in order for site E to be phosphorylated.

A conditional rule (indicated by “crl”) 336 was formulated to specify that if pRB is phosphorylated at both site D and site E, it cannot bind to the E2F1•DPi complex.

Rules were also generated to model the G1 to S phase transition. A rewriting rule ([10]) was generated for the binding of the inhibitor CipKip to the cyclin D-CDK4 (cycD:cdk4) complex. This complex is only formed when a MITOGENICSIGNAL is present. When the growth factor TGF-β is present, the cyclin-dependent kinase inhibitors (CKI) Ink4a and Ink4b are produced (Rule [11]). Ink4a and Ink4b were typed as CKIs, thus rules could be generated for CKIs without having to specify the exact CKI species. Rule [12] modeled the binding of the CKIs (e.g., Ink4a and Ink4b) to the complex of cycD:cdk4:CIPKIP, which results in cycD phosphorylation and then destruction (rule [13]).

Rule [16] was formulated to express the phosphorylation of pRB 330 by active cyclin D:cdk4 314 complexes. This phosphorylation disrupts the pRB:EF2:DP1 complex 372 and allows E2F1:DP1 364 to activate 394 transcription of cyclinE 390 (Rule [17]) and cause cells to enter S phase (Rule [18]). Rule [19] models the formation of cyclin E-cdk2 complexes, and rule [15] models the inactivation of cyclin E:cdk2 complexes by CIPKIP.

Models such as the one described here have been used to run simulations of biological systems using symbolic representation. Output included determination of all possible states leading to the G1/S checkpoint in a mammalian cell, and determination of all possible resultant states given a mitogenic signal outside the cell.

### Other Embodiments

Other embodiments are within the scope of the following claims.

For example, multiple different cells may be modeled, e.g., a cell for each major organ and cell-type in a subject. Such a system can include general rules and symbols for components common to all cells of the subject, as well as rules and symbols particular to a cell-type. Thus, the general response of an organism to disease, genetic mutation, or environmental change can be simulated and studied. Further the process of development and differentiation can be modeled in the organism, e.g., from an embryo to adult stages.

In another example, the rules and symbols may be used to model each individual cell of a population. For example, a system for monitoring pancreatic behavior might include rules and symbols for each of 10,000 α islet cells, 5,000β islet cells, and 1,000 γ islet cells.

What is claimed is:

1. A method comprising:
generating a model of a biological system, the model comprising rules that express a substitution of at least one symbol by at least another symbol, the symbols representing a biological element, and at least some of the rules being expressed in a manner that enables an inference engine to infer alternative results from the system based on an initial hypothetical state.

2. The method of claim 1 wherein one or more of the rules comprises an operator for expressing a relationship between at least two of the biological elements, the operator conforming to associative and commutative properties.

3. The method of claim 1 wherein one or more of the miles expresses concurrent state transitions.

4. The method of claim 1 wherein at least some of the rules are not terminating.

5. The method of claim 1 wherein at least one of the rules represents a feedback or feedforward interaction between biological elements.

6. The method of claim 1 wherein one or more of the rules is reflective.

7. The method of claim 1 wherein one or more of the symbols representing the biological elements is typed.

8. The method of claim 7 wherein the types of symbols are organized in hierarchical classes.

9. The method of claim 8 wherein a symbol for one of the hierarchical classes is matched by any symbol that is a member of the hierarchical class.

10. The method of claim 1 wherein at least some of the rules are conditional.

11. The method of claim 1, further comprising expressing the rules graphically by representing at least some of the symbols as points and at least some of rules as lines interconnecting points, each interconnected point corresponding to a symbol that is an operand of the rule.

12. The method of claim 1 wherein one or more of the symbols represents a polypeptide selected from the group consisting of a protein kinase, a transcription factor, a cytokine, and a nucleotide binding protein.

13. The method of claim 1 wherein one or more of the symbols represents a polypeptide selected from the group consisting of pRB, cyclins, cyclin-dependent kinases, cyclin-dependent kinase inhibitors, p53, E2F, and DP1.

14. The method of claim 1 wherein one or more of the symbols represents a drug or exogenous agent.

15. The method of claim 1 wherein one or more of the symbols represents post-translational modification.

16. The method of claim 1 wherein the model of the biological system includes a first set of symbols representing molecules in a first cell and a second set of symbols representing molecules in a second cell.

17. The method of claim 16 wherein one or more of the first set of symbols comprises the same symbols of the second set.

18. An article comprising machine-readable media having encoded thereon a model of a biological system, the model comprising rules that express a substitution of at least one symbol by at least another symbol, the symbols representing a biological element, and at least one of the rules being expressed in a manner that enables an inference engine to infer alternative results from the system based on an initial hypothetical state.

19. The article of claim 18 wherein one or more of the rules comprises an operator for expressing a relationship between at least two of the biological elements, the operator conforming to associative and commutative properties.

20. The article of claim 18 wherein one or more of the rules expresses concurrent state transitions.

21. The article of claim 18 wherein at least some of the rules are not terminating.

22. The article of claim 18 wherein at least one of the rules represents a feedback or feedforward interaction between biological elements.

23. The article of claim 18 wherein one or more of the rules is reflective.

24. The article of claim 18 wherein one or more of the symbols representing the biological elements is typed.

25. The article of claim 24 wherein the types of symbols are organized in hierarchical classes.

26. The article of claim 25 wherein a symbol for one of the hierarchical classes is matched by any symbol that is a member of the hierarchical class.

27. The article of claim 18 wherein at least some of the rules are conditional.

28. The article of claim 18 wherein one or more of the symbols represents a polypeptide selected from the group consisting of a protein kinase, a transcription factor, a cytokine, and a nucleotide binding protein.

29. The article of claim 18 wherein one or more of the symbols represents a polypeptide selected from the group consisting of pRB, cyclins, cyclin-dependent kinases, cyclin-dependent kinase inhibitors, p53, E2F, and DP1.

30. The article of claim 18 wherein one or more of the symbols represents a drug or exogenous agent.

31. The article of claim 18 wherein one or more of the symbols represents post-translational modification.

32. The article of claim 18 wherein the model of the biological system includes a first set of symbols representing molecules in a first cell and a second set of symbols representing molecules in a second cell.

33. The article of claim 32 wherein one or more of the first set of symbols comprises the same symbols of the second set.

34. A method comprising:
receiving a set of symbols in an inference engine, the set representing a hypothetical initial state of a biological system, the symbols representing elements of the biological system; and
processing the initial state using rules that express a substitution of at least one of the symbols by at least another symbol representing a biological element to infer alternative resultant states of the system.

35. The method of claim 34 wherein the set of symbols representing the hypothetical initial state is generated from an expression profile for a biological sample.

36. The method of claim 34, further comprising: parsing a profile for a biological sample into symbols; and include at least some of the symbols in the set of symbols representing a hypothetical initial state of the biological system.

37. The method of claim 36 wherein the profile is a gene expression profile.

38. The method of claim 36 wherein the profile is a polypeptide profile.

39. The method of claim 36 wherein the biological sample is associated with a disease or disorder.

40. The method of claim 39 wherein the disease or disorder is selected from the group consisting of cancer, diabetes, infection by a pathogen, inflammation, and a disease of aging.

41. The method of claim 34 wherein infinite substitution chains are detected.

42. The method of claim 34 wherein values of one or more of the symbols of the resultant states are displayed graphically as a wiring diagram.

43. The method of claim 42 wherein the wiring diagram comprises a graph having lines interconnecting points, each line corresponding to a rule such that each interconnected point of the line corresponds to a symbol that is an operand of the rule.

44. The method of claim 34, further comprising: comparing each of the alternative resultant states to one or more reference states.

45. The method of claim 44 wherein the one or more reference states comprise a state associated with cell proliferation, cell quiescence, cell apoptosis, and cell differentiation.

46. The method of claim 44 wherein the alternative resultant states are compared to two or more reference states, each reference state being associated with a diagnosis.

47. The method of claim 44 wherein the hypothetical initial state represents a sample from a patient.

48. The method of claim 34 wherein the set of symbols representing hypothetical initial state comprises a symbol representing a genetic alteration.

49. The method of claim 44 wherein the one or more reference states comprise a state associated with a disease or disorder.

50. The method of claim 49 wherein the disease is selected from the group consisting of cancer, diabetes, infection by a pathogen, inflammation, and a disease of aging.

51. The method of claim 34 wherein one or more of the rules comprises an operator for expressing a relationship between at least two of the biological elements, the operator conforming to associative and commutative properties.

52. The method of claim 34 wherein one or more of the rules expresses concurrent state transitions.

53. The method of claim 34 wherein at least some of the rules are not terminating.

54. The method of claim 34 wherein at least one of the rules represents a feedback or feedforward interaction between biological elements.

55. The method of claim 34 wherein one or more of the rules is reflective.

56. The method of claim 34 wherein one or more of the symbols representing the biological elements is typed.

57. The method of claim 56 wherein the types of symbols are organized in hierarchical classes.

58. The method of claim 57 wherein a symbol for one of the hierarchical classes is matched by any symbol that is a member of the hierarchical class.

59. The method of claim 34 wherein at least some of the rules are conditional.

60. The method of claim 34 wherein one or more of the symbols represents a polypeptide selected from the group consisting of a protein kinase, a transcription factor, a cytokine, and a nucleotide binding protein.

61. The method of claim 34 wherein one or more of the symbols represents a polypeptide selected from the group consisting of pRB, cyclins, cyclin-dependent kinases, cyclin-dependent kinase inhibitors, p53, E2F, and DP1.

62. The method of claim 34 wherein one or more of the symbols represents a drug or exogenous agent.

63. The method of claim 34 wherein one or more of the symbols represents post-translational modification.

64. The method of claim 34 wherein the model of the biological system includes a first set of symbols representing molecules in a first cell and a second set of symbols representing molecules in a second cell.

65. The method of claim 64 wherein one or more of the first set of symbols comprises the same symbols of the second set.

66. A method comprising:
receiving a set of symbols in an inference engine, the set of symbols representing a hypothetical initial state of a biological system, the symbols representing biological elements of the system; and
iteratively substituting at least one of the symbols by at least another symbol representing a biological element using rules that represent interactions between the biological elements until a terminal state is detected or until alternative resultant states are detected.

67. The method of claim 66, further comprising outputting the terminal state or at least one of the alternative resultant states.

68. The method of claim 66 wherein the hypothetical initial state represents a biological sample from a patient.

69. The method of claim 68 wherein the biological sample is associated with a disease or disorder.

70. The method of claim 69 wherein the disease or disorder is selected from the group consisting of cancer, diabetes, infection by a pathogen, inflammation, and a disease of aging.

71. The method of claim 66, further comprising parsing a profile for a biological sample into symbols; and include at least some of the symbols in the set of symbols representing a hypothetical initial state of the biological system.

72. The method of claim 66, further comprising: comparing each of the alternative resultant states to one or more reference states.

73. The method of claim 72 wherein the one or more reference states comprise a state associated with cell proliferation, cell quiescence, cell apoptosis, and cell differentiation.

74. The method of claim 72 wherein the alternative resultant states are compared to two or more reference states, each reference state being associated with a diagnosis.

75. The method of claim 66 wherein the set of symbols representing hypothetical initial state comprises a symbol representing a genetic alteration.

76. The method of claim 66 wherein one or more of the symbols representing the biological elements is typed.

77. A method comprising:
receiving into an inference engine a rule set comprising rules that express a substitution of one or more of the symbols representing biological elements by at least another symbol representing a biological element; and determining a property of the rule set.

78. The method of claim 77 wherein the property comprises an indicator of whether the rules set is terminating.

79. The method of claim 77 wherein the property comprises an indicator of whether the rule set includes one or more rules expressing a feedback or feedforward interaction.

80. The method of claim 77 wherein the determining comprises associative-commutative matching.

81. The method of claim 77 further comprising generating a decision diagram.

82. A method comprising:
receiving into an inference engine (1) at least a first and a second set of symbols wherein the first set of symbols represents a hypothetical first state of a biological system, and the second set of symbols represents a hypothetical second state of the biological system, and the symbols represent biological elements of the biological system, and (2) rules that express a substitution of one or more of the symbols representing biological elements by at least another symbol representing a biological element; and
determining if one or more of the rules must be true or false for the first state to reach the second state by processing the first state using the rules.

83. The method of claim 82 wherein the hypothetical first state represents a hypothetical reference sample, the hypothetical second state represents a sample associated with a disease or disorder, and a rule determined to be true identifies biological elements represented by its operands as drug targets.

84. The method of claim 82, further comprising
identifying a first profile for a first sample associated with the hypothetical first state of the biological system,
identifying a second profile for a second sample associated with the hypothetical second state of the biological system; and
parsing the first and second profiles to produce the first and a second set of symbols.

85. The method of claim 84 wherein the first and second samples have one or more genetic alterations with respect to one another.

86. The method of claim 84 in which the first and second profiles include information about mRNA expression.

87. The method of claim 84 in which the first and second profiles include information about polypeptide abundance.

88. The method of claim 84 in which the first and second profiles include information about polypeptide modification.

89. The method of claim 84 in which the first and second profiles include information about metabolite abundance.

90. The method of claim 82 in which one or more of the rules expresses concurrent state transitions.

91. The method of claim 82 in which at least some of the rules are not terminating.

92. The method of claim 82 in which at least one of the rules represents a feedback or feedforward interaction between biological elements.

93. The method of claim 82 in which at least one or more of the symbols representing the biological elements is typed.

94. The method of claim 93 in which the types of symbols are organized in hierarchical classes.

95. The method of claim 82 wherein the hypothetical first state represents a hypothetical reference sample, the hypothetical second state represents a sample contacted with a drug or exogenous agent, and a rule determined to be true identifies biological elements represented by its operands as drug targets.

96. An article comprising machine-readable media having encoded thereon software configured to cause the processor to:
receive a set of symbols, the set representing a hypothetical initial state of a biological system, the symbols representing biological elements of the system; and
iteratively substitute one or more of the symbols representing biological elements by at least another symbol representing a biological element using rules that represent interactions between the biological elements until a terminal state or until alternative resultant states are detected.

97. The article of claim 96 wherein one or more of the rules comprises an operator for expressing a relationship between at least two of the biological elements, the operator conforming to associative and commutative properties.

98. The article of claim 96 wherein one or more of the rules expresses concurrent state transitions.

99. The article of claim 96 wherein at least some of the rules are not terminating.

100. The article of claim 96 wherein at least one of the rules represents a feedback or feedforward interaction between biological elements.

101. The article of claim 96 wherein one or more of the rules is reflective.

102. The article of claim 96 wherein one or more of the symbols representing the biological elements is typed.

103. The article of claim 102 wherein the types of symbols are organized in hierarchical classes.

104. The article of claim 103 wherein a symbol for one of the hierarchical classes is matched by any symbol that is a member of the hierarchical class.

105. The article of claim 96 wherein the software is further to cause the processor to: receive a second set of symbols for a hypothetical second state of the biological system; and compare the second set of symbols to the terminal state or to at least one of the alternative resultant states.

106. An article comprising machine-readable media having encoded thereon software configured to cause the processor to:
receive information for a first state of a biological system;
generate symbols representing biological elements of the system; and
iteratively substitute one or more of the symbols representing biological elements by at least another symbol representing a biological element using rules that represent interactions between the biological elements until a terminal state or until alternative resultant states are detected.

107. The article of claim 106 wherein one or more of the symbols representing the biological elements is typed.

108. The article of claim 106 wherein the information comprises values, each value reflecting the abundance of a biological element in the first state.

109. The article of claim 108 wherein generating comprises comparing each value to a threshold parameter for the value, and generating a symbol for the biological element whose abundance is reflected by the value if the value exceeds the threshold parameter.
